(19) United States
(12) Patent Application Publication
(10) Pub. No.: US 2024/0144117 A1
(43) Pub. Date: May 2, 2024

(54) SYSTEM AND METHOD USING ARTIFICIAL INTELLIGENCE (AI) AND ADVANCED NATURAL LANGUAGE UNDERSTANDING (NLU) TO ENABLE CHILDREN TO SOCIALLY ENGAGE WITH OTHER CHILDREN ON A SECURED VIRTUAL PLATFORM

(71) Applicants: Venkat Rajagopala, Huntington, NY (US); Vikesh Dalal, Plainview, NY (US)

(72) Inventors: Venkat Rajagopala, Huntington, NY (US); Vikesh Dalal, Plainview, NY (US)

(21) Appl. No.: 18/498,986

(22) Filed: Oct. 31, 2023

Related U.S. Application Data
(60) Provisional application No. 63/381,803, filed on Nov. 1, 2022.

(51) Int. Cl. G06Q 10/0631

(52) U.S. Cl. CPC G06Q 10/06311

(57) ABSTRACT

A system and method for scheduling, managing and executing, or otherwise conducting, virtual playdates though the use of separate mobile or other devices is presented herein. More specifically, the present invention is directed to a system and method that enables and provides for a safe and secure environment for children to interact with one another in a virtual and remote platform, while maintaining parental control, oversight and other forms of safety features and enhancements.

### CLAIM OF PRIORITY/CROSS-REFERENCE TO RELATED APPLICATION

The present application is based on and a claim of priority is made under 35 U.S.C. § 119(e) to U.S. Provisional Patent Application No. 63/381,803, filed on Nov. 1, 2022, the contents of which are incorporated herein in their entirety by reference.

### FIELD OF THE INVENTION

The present invention is generally directed to a system and method for scheduling, managing and executing, or otherwise conducting, virtual playdates though the use of separate mobile or other devices. In some embodiments the system and method uses artificial intelligence (AI) and advanced natural language understanding (NLU) to enable children to socially engage with other children on a secured virtual platform. More specifically, the present invention is directed to a system and method that enables and provides for a safe and secure environment for children to interact with one another in a virtual and remote platform, while maintaining parental control, oversight and other forms of safety features and enhancements.

### BACKGROUND OF THE INVENTION

People tend to rely on the use of technology and social platforms for increased social interactions, particularly since the COVID-19 pandemic, although not limited to such. Children are also often exposed to social networks and other like websites at an early age; however it is well-known that involving children in such networks and environments can expose them to potentially dangerous situations or people with nefarious intentions.

While parental controls, passwords and other like settings may be used to minimize the exposure of children to dangerous online environments and/or interactions, they may also be overly restrictive and underinclusive.

Accordingly, there is a strong need in the art for a system and method for scheduling, managing and conducting virtual playdates though the use of separate mobile or other devices in a safe and secure manner. The proposed system and method may use artificial intelligence (AI) and advanced natural language understanding (NLU) to enable children to socially engage with other children on a secured virtual platform, while also maintaining parental control, oversight and other forms of safety features and enhancements.

### SUMMARY OF THE INVENTION

The present invention is generally directed to a way in which children are able to play together online in a safe and secure manner. For instance, various embodiments of the system and method described herein enable a more inclusive and safer environment for children to interact with one another online or through a virtual platform. In particular, using the system or application of the present invention, the children are able to play games in real-time, video chat one-on-one or in a group, or even read together. Parents have the option of scheduling playtimes so that they do not need to always be in front of the children and monitoring them all the time. The parents can just choose a time slot, and when the child is connected with friends, the parent knows exactly what is happening. More specifically, the system and method of the present invention provides complete control over who their children connect with, what interactions they have and the ability to schedule play times online.

Moreover, the present invention presents the first child-friendly network where children are able to connect with friends in a safe and fun environment. Parents have peace of mind knowing that their children are protected and safe during scheduled virtual playdates.

These and other objects, features and advantages of the present invention will become more apparent when the drawings as well as the detailed description are taken into consideration.

### BRIEF DESCRIPTION OF DRAWINGS

FIG. 1 is a block diagram of the system as disclosed in accordance with at least one embodiment of the present invention.

FIG. 2A is a block diagram of at least some components of the management system as disclosed in accordance with at least one embodiment of the present invention.

FIG. 2B is a block diagram of at least some components of the user devices as disclosed in accordance with at least one embodiment of the present invention.

FIG. 3 is a high-level flow chart of the method as disclosed in accordance with at least one embodiment of the present invention.

FIG. 4A is a flow chart illustrating the login and registration for a parent as disclosed in accordance with at least one embodiment of the present invention.

FIG. 4B is a flow chart illustrating managing requests from the parent device as disclosed in accordance with at least one embodiment of the present invention.

FIG. 4C is a flow chart illustrating the access times flow as disclosed in accordance with at least one embodiment of the present invention.

FIG. 4D is a flow chart illustrating the chat feature as disclosed in accordance with at least one embodiment of the present invention.

FIG. 5A is a flow chart illustrating the login and registration flow for a child or participant as disclosed in at least one embodiment of the present invention.

FIG. 5B is a flow chart illustrating the schedule flow as disclosed in accordance with at least one embodiment of the present invention.

FIG. 5C is a flow chart illustrating the activity flow as disclosed in accordance with at least one embodiment of the present invention.

FIG. 5D is a flow chart illustrating a friend request flow as disclosed in accordance with at least one embodiment of the present invention.

FIG. 6A is an exemplary screenshot illustrating the parent sign up and log in as disclosed in accordance with at least one embodiment of the present invention.

FIG. 6B is an exemplary screenshot illustrating a landing screen as disclosed in accordance with at least one embodiment of the present invention.

FIG. 6C is a series of exemplary screenshots illustrating the parent registration process as disclosed in accordance with at least one embodiment of the present invention.

FIG. 6D is an exemplary screenshot illustrating the parent dashboard as disclosed in accordance with at least one embodiment of the present invention.

FIG. 6E is an exemplary screenshot illustrating a request as displayed on the parent device as disclosed in accordance with at least one embodiment of the present invention

FIG. 6F is an exemplary screenshot illustrating the schedule module as disclosed in accordance with at least one embodiment of the present invention.

FIGS. 7A1 and 7A2 are an exemplary screenshots illustrating the child sign-in screen and approval pending screen, respectively, as disclosed in accordance with at least one embodiment of the present invention.

FIG. 7B is an exemplary screenshot illustrating a landing screen as disclosed in accordance with at least one embodiment of the present invention.

FIGS. 7C1 through 7C4 are exemplary screenshots illustrating a child registration process as disclosed in accordance with at least one embodiment of the present invention.

FIG. 7D is an exemplary screenshot illustrating the child dashboard as disclosed in accordance with at least one embodiment of the present invention.

FIGS. 7E1 through 7E6 are exemplary screenshots illustrating a child schedule as disclosed in accordance with at least one embodiment of the present invention.

FIGS. 7F1 through 7F4 are exemplary screenshots illustrating a video call process as disclosed in accordance with at least one embodiment of the present invention.

FIGS. 7G1 through 7G7 are exemplary screenshots illustrating a game play process as disclosed in accordance with at least one embodiment of the present invention.

FIGS. 7H1 through 7H5 are exemplary screenshots illustrating a reading process as disclosed in accordance with at least one embodiment of the present invention.

FIG. 7I is an exemplary screenshot illustrating a chat module as displayed on the child device as disclosed in accordance with at least one embodiment of the present invention.

FIGS. 7J1 through 7J7 are exemplary screenshots illustrating a friend list and request process as disclosed in accordance with at least one embodiment of the present invention.

FIG. 8 is a block diagram illustrating the third-party user-identification authentication or validation module as disclosed in accordance with at least one embodiment of the present invention.

FIG. 9 is a block diagram illustrating the behavioral analysis process and module as disclosed in accordance with at least one embodiment of the present invention.

Like reference numerals refer to like parts throughout the several views of the drawings provided herein.

### DETAILED DESCRIPTION OF THE INVENTION

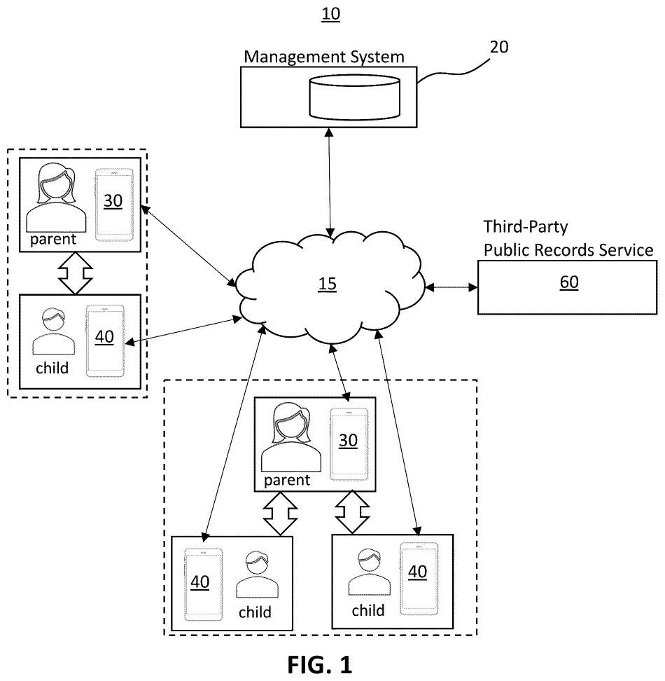

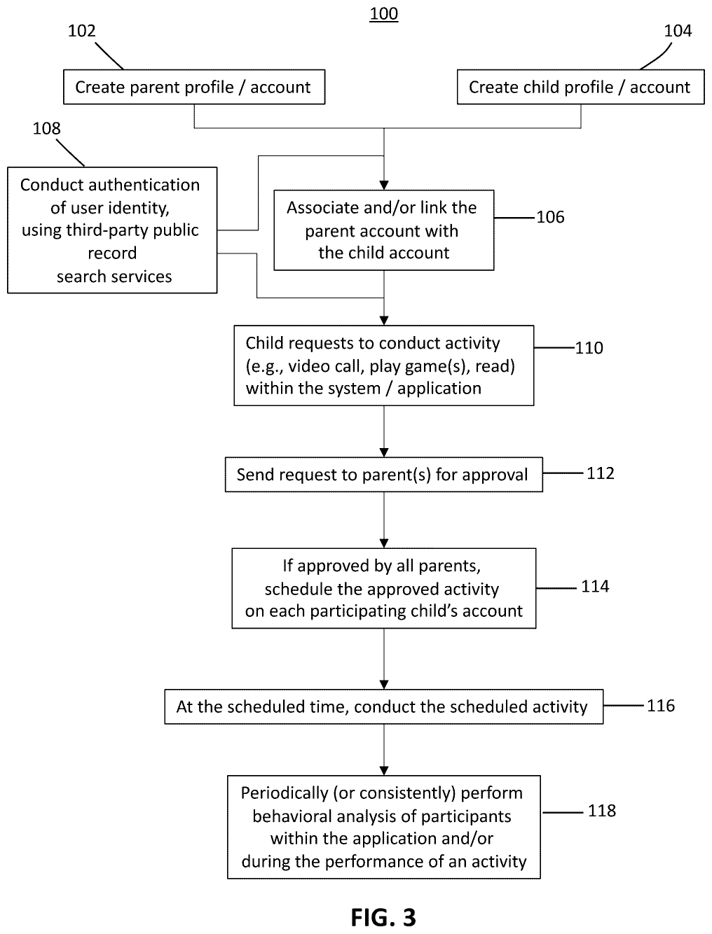

As shown in the accompanying drawings, and with particular reference to FIGS. 1 and 3, the present invention is directed to a system 10 and a method 100, respectively, for enabling virtual playdates between one or more participants or children. More specifically, the virtual playdates may include one or more various activities or interactions between one or more participants of the system 10 and/or method 100, and may include, but are in no way limited to, audio and/or video chats or calls, text-based chats or messaging, playing one or more games with one another or individually, reading individually, together or to one another, listening to a reader or music, etc.

It should also be noted that the participants of the virtual playdate(s) may often be children or minors, however, the disclosure of the present invention is not limited to such and thus the participants of the virtual playdates, as used herein, may include people or individuals of any age, whether children, teenagers, minors or adults, including special needs individuals. It should be apparent that the participants of certain embodiments is a fully inclusive group and is not discriminatory or exclusionary with regard to age, gender, orientation, physical, mental or other disability, etc.

Furthermore, while the term ‘parent’ is often used throughout this disclosure, a parent may also be considered a guardian, caretaker, supervisor, or other individual with a similar role to the child or participant.

Furthermore, as shown in the high-level block diagram of FIG. 1, the system 10 of at least one embodiment includes at least one management system, generally referenced as 20, disposed in a communicative relation with a plurality of user devices 30, 40, for example, via a network 15. As an example, the network 15 may include virtually any computer, communication or data network such as the World Wide Web, Internet, Intranet, Wide Area Network(s), Telecommunication Network(s) (e.g., 3G, 4G, 5G, LTE), etc. Moreover, the management system 20, as disclosed in connection with certain embodiments of the present invention is structured and/or configured to manage, store and process account or profile information (e.g., usernames, passwords, account information, contacts, etc.), and facilitate the scheduling, management and execution of virtual playdates, for example, via one or more applications 50 and/or modules operating on or accessible by the one or more user devices 30, 40, as described herein.

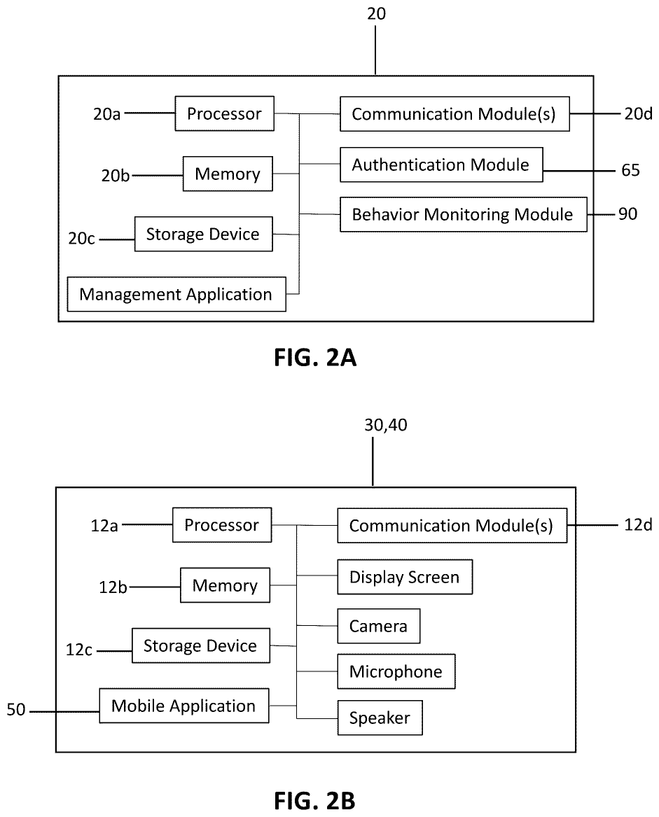

In this manner, the management system 20 of at least one embodiment of the present invention may include at least one web or cloud-based computer or server, desktop computer, laptop computer, tablet, mobile or handheld computer, etc. capable of facilitating implementation of the present invention disclosed herein. Particularly, with reference to the block diagram of FIG. 2A, it is noted that the platform and/or management system 20 of at least one embodiment includes, among other components and devices structured to facilitate implementation of the present invention in the intended manner, a computer processor 20a, memory 20b, one or more data storage devices 20c, and one or more communication or network device(s) 20d.

Specifically, as used herein, the processor 20a of at least one embodiment may include any device cooperatively structured to execute or implement computer instructions, software, etc., including, for example, the various features and components as described in accordance with at least one embodiment of the present invention and configured to implement or facilitate the implementation of the method 100 herein. Further, the memory device 20b, as used herein, may include but is not limited to random access memory (RAM) or other like device(s) configured to implement the present invention in the intended manner, for example, by storing and assisting with the execution of one or more applications, modules, or components capable of implementing the system 10 and method 100 described herein. It should be noted that non-transitory computer readable media includes all computer-readable media except for a transitory, propagating signal. The data storage device(s) 20c, as used herein, may include a hard disk drive, CD/DVD, USB drive, solid state drive, virtual drive, could-based storage drive, or other types of volatile or non-volatile memory. Moreover, the communication device 20d may include a network communication hardware/software component structured to facilitate communication between the management platform/system 20 of the present invention and the various user devices 30, 40.

Furthermore, the user devices, as disclosed herein may be referenced as a parent device 30 or a child or participant device 40, and may include virtually any computer-based device configured to or capable of implementing various aspects of the present invention. In this manner, the user devices 30, 40 may include, but are not limited to, mobile devices or mobile terminals such as, for example, mobile phones, smartphones, tablet computers, etc., as well as laptop or mobile computers, desktop computers, video game consoles, mobile video game devices, etc. Accordingly, in some embodiments or implementations, the user or mobile device(s) 30 may include, for example, an APPLE® iPHONE®, APPLE® iPAD®, ANDROID® based phone or tablet, etc. In any event, the user devices 30, 40 of the various embodiments are capable of accessing one or more of the mobile applications 50 described herein.

With reference to the schematic representation or block diagram illustrated in FIG. 2B, in at least one exemplary embodiment, each user device 30, 40 may include, among other components and devices structured to facilitate implementation of the present invention in the intended manner, a computer processor 12a, memory 12b, at least one data storage device 12c, and a communication or network device(s) 12d. In order to facilitate some features of the present invention, the user device(s) 30, 40 may also include one or more display screens, such as a touchscreen or other screen, a camera or other video capturing device, a microphone or other audio capturing device, and other input/output devices or modules.

Moreover, as used herein, the processor 12a of at least one embodiment may include any device cooperatively structured to execute or implement computer instructions, software, etc., including, for example, the various features and components as described in accordance with at least one embodiment of the present invention and configured to implement the method 100 herein. Further, the memory device 12b as used herein, may include but is not limited to random access memory (RAM) or other like devices configured to implement the present invention in the intended manner, for example, by storing and assisting with the execution of one or more applications, modules, or components capable of implementing the system 10 and method 100 described herein. It should be noted that non-transitory computer readable media includes all computer-readable media except for a transitory, propagating signal. The data storage device 12c, as used herein, may include a hard disk drive, CD/DVD, USB drive, solid state drive, virtual drive, could-based storage drive, or other types of volatile or non-volatile memory. Moreover, the communication device 12d may include a network communication hardware/software component structured to facilitate communication with the network 15.

In some cases, the user devices 30, 40 may have (e.g., downloaded and/or installed) or otherwise be able to access (e.g., locally or remotely) a mobile or other application, generally referenced as 50 throughout the drawings. The application 50, as used herein, may be specifically configured to facilitate implementation of the various embodiments disclosed herein, for example, by providing an interface for parents to access the system 10 or method 100 (e.g., to manage one or more child profiles or accounts or to otherwise interact with the system 10 and/or method 100 in various ways as described herein) and/or by providing an interface for children or other participants to access the system 10 or method 100 (e.g., to interact with other participants, to engage in a scheduled playdate, or to interact with the system 10 and method 100 in various ways as described herein). In some cases, a parent or participant (e.g., child) may access the system 10 or method 100 in other ways, for example, by using or accessing a web browser on the user device 30, 40 and by directing the web browser to a particular web page.

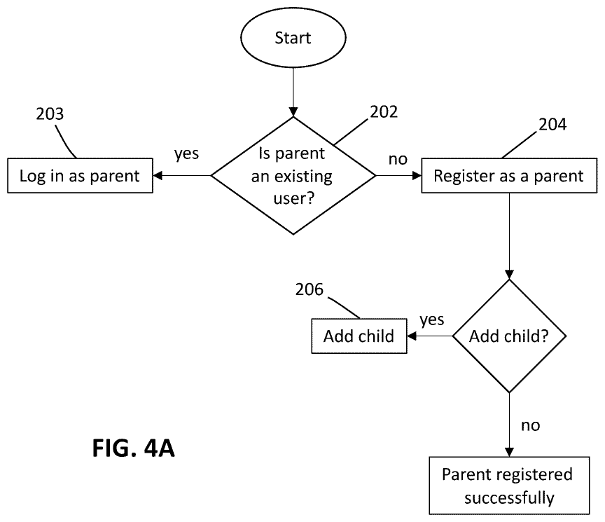

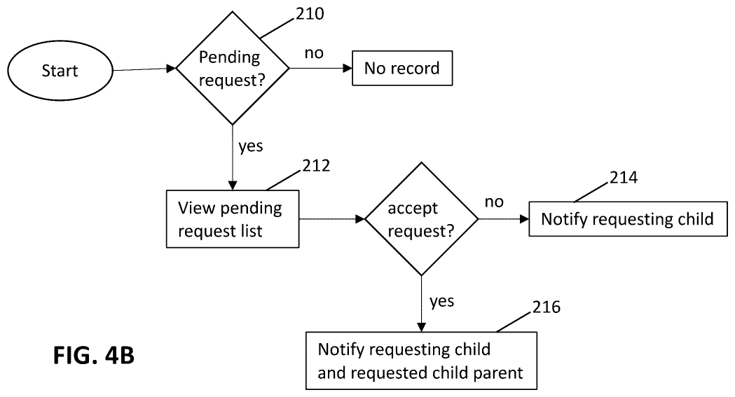

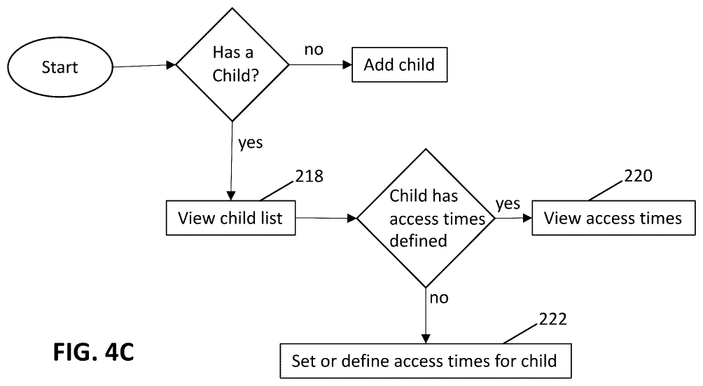

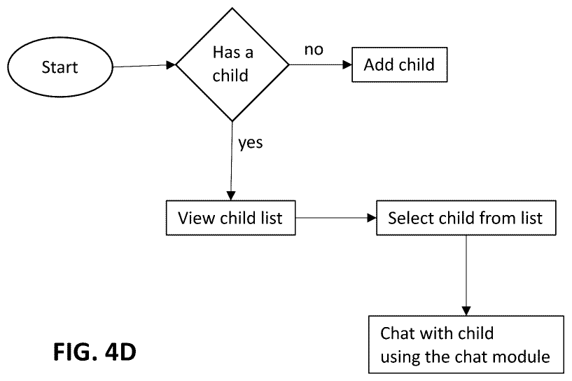

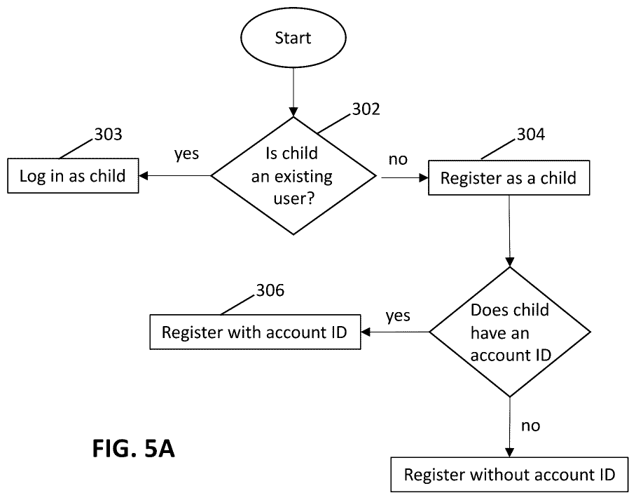

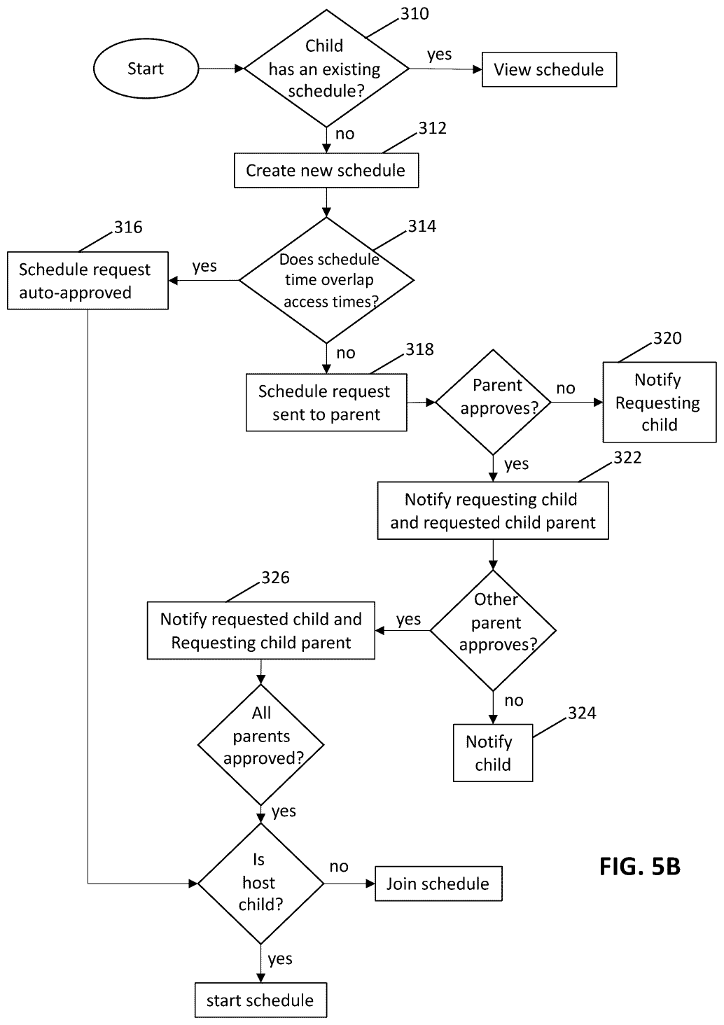

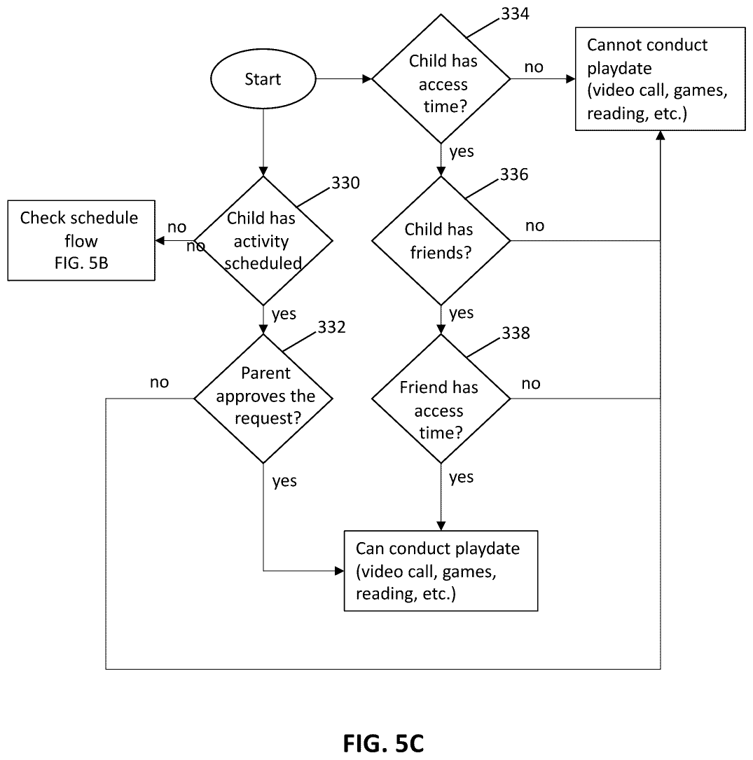

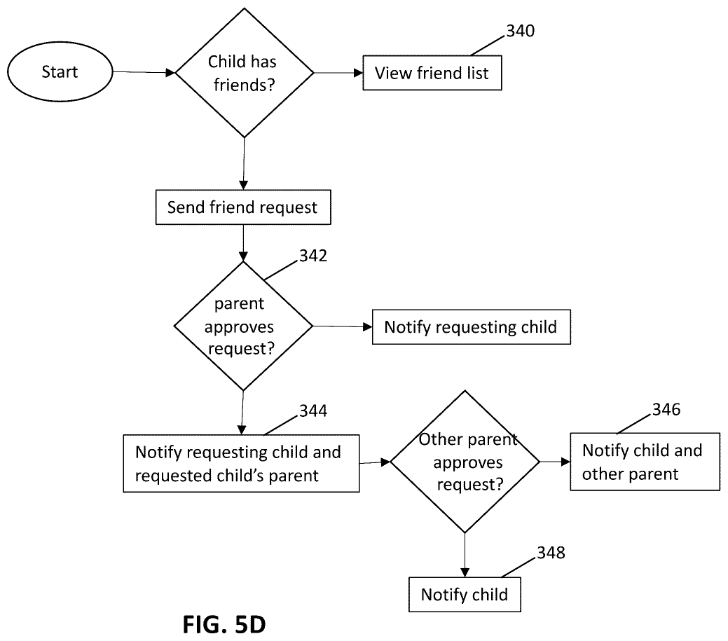

Referring again to the high-level flow chart of FIG. 3, the method 100 of at least one embodiment includes creating profiles or accounts for at least one parent (referenced as 102) and at least one participant or child (referenced as 104). More specifically, in order to access the system 10 or method 100 of at least one embodiment the present invention, the users (e.g., the parents and children) must first register or otherwise create an account/profile. FIG. 4A represents a flow chart showing the login and sign-up process for a parent, whereas FIG. 5A represents a flow chart showing the login and sign-up process for a child or other participant.

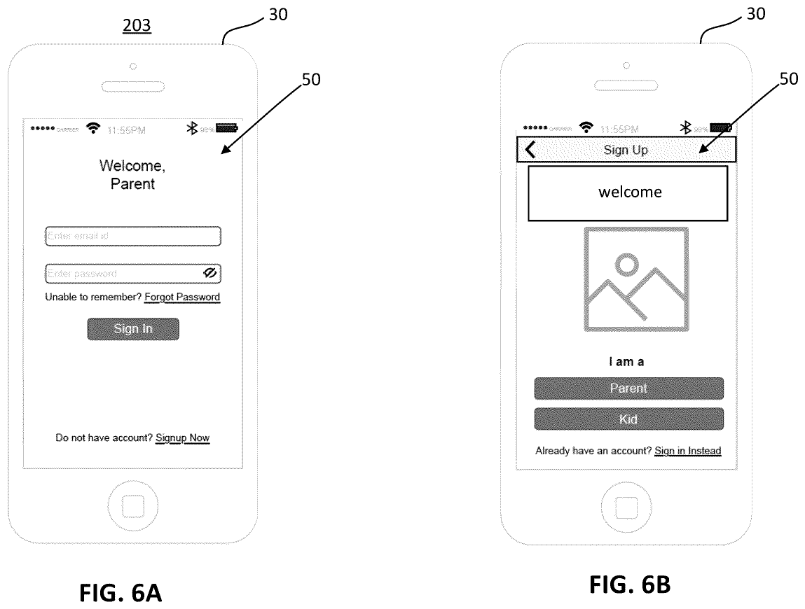

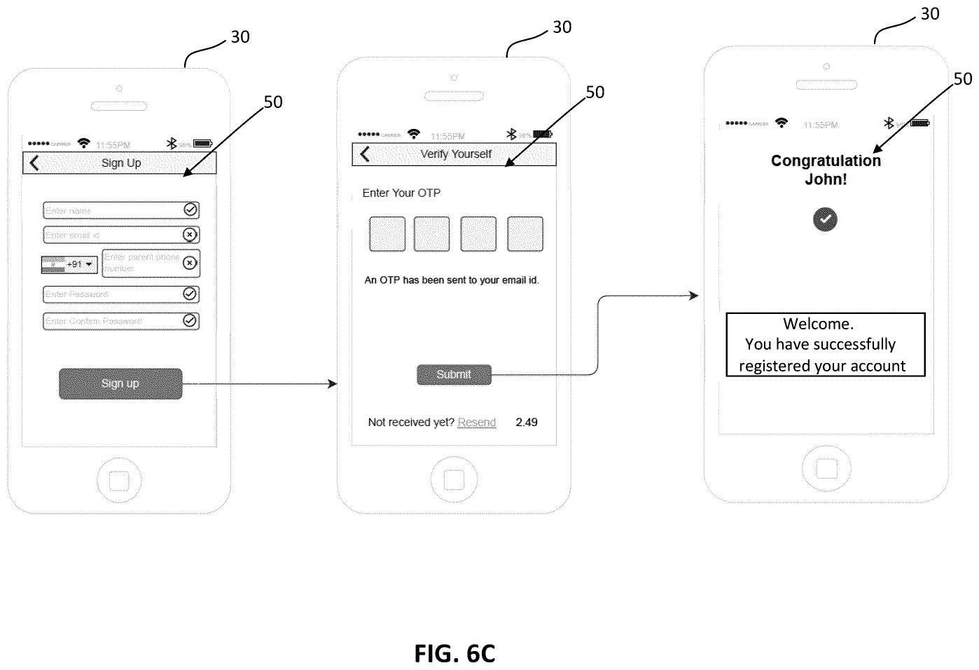

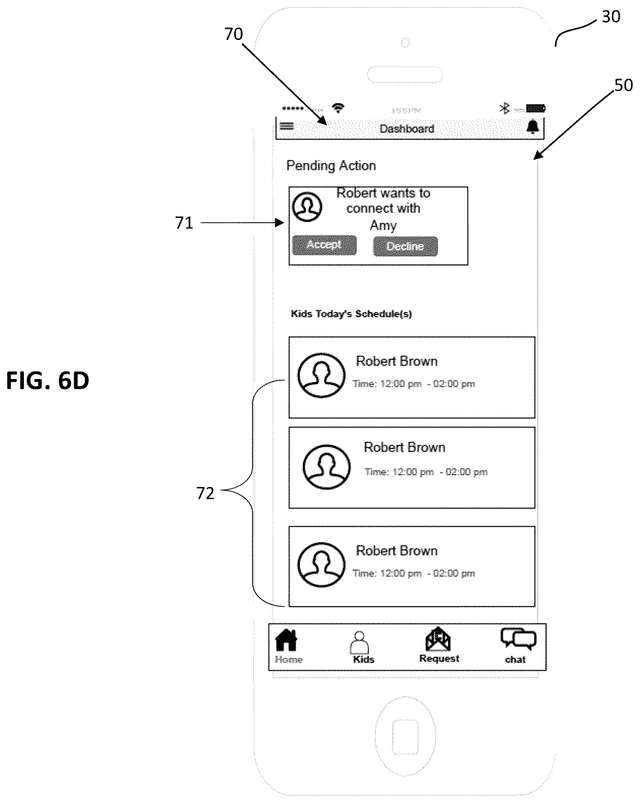

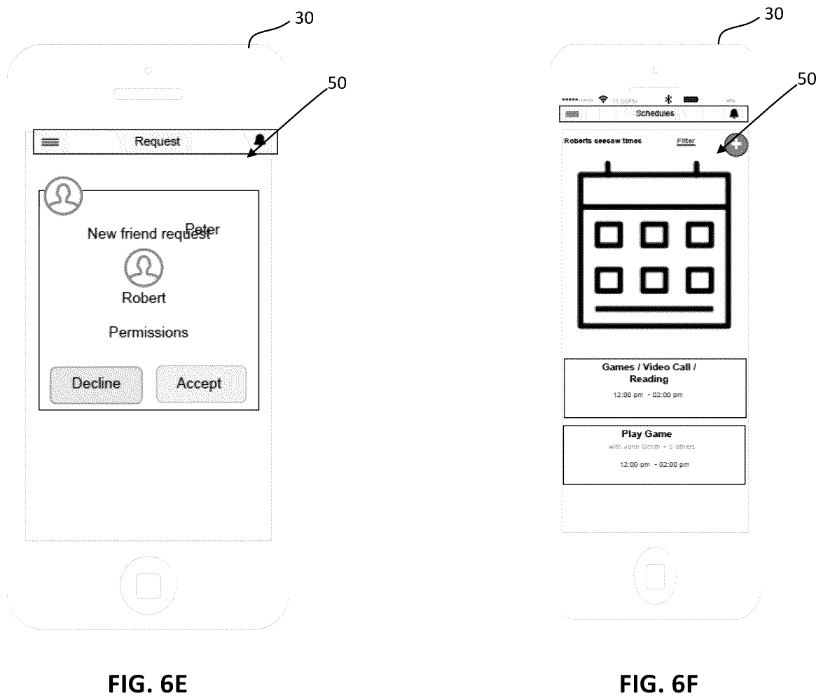

For example, at reference 202 in FIG. 4A, if the parent is an existing user, the parent will login to the system 10 or method 100 using his or her previously assigned, acquired or provided credentials (e.g., username, email, account ID, password, etc.) at 203. With reference to FIG. 6A, an exemplary login screen or module 203 is shown for a parent or guardian to access the system 10 or method 100 of the present invention.

If, on the other hand, the parent or guardian is not registered, then the parent may do so, as referenced at 204, by providing identifying information (e.g., name, email address, phone number, password, etc.) For example, as shown in FIG. 6B, when a user selects “sign up now” or otherwise indicates a desire to register, in some embodiments, the user may be provided the option to identify as or indicate the role as a parent or as a child. Selecting to sign-up as a parent will, in some embodiments, direct the user to the parent sign up module 204, as exemplified in the screenshot flows of FIG. 6C. More specifically, a user/parent may provide various identifying or other registration information, such as name, phone number, email address, etc. to register an account or profile with the system 10 or method 100. In some cases, as shown in FIG. 6C, a one-time password (OTP) or other like method may be provided to the user/parent (e.g., via email, text message, etc.) for purposes of authenticating the information provided by the user. Other multi-factor authentication methods or processes may be implemented in other embodiments to provide additional authentication of the identity of the user and/or the accuracy of the identifying information provided thereby.

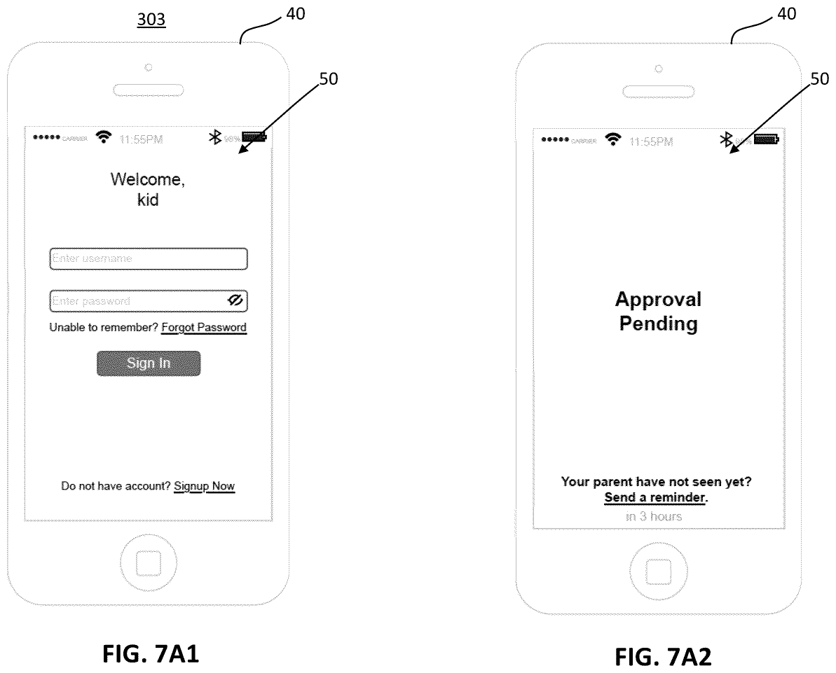

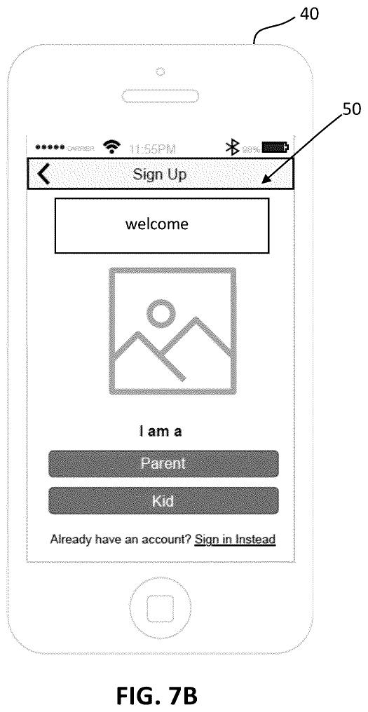

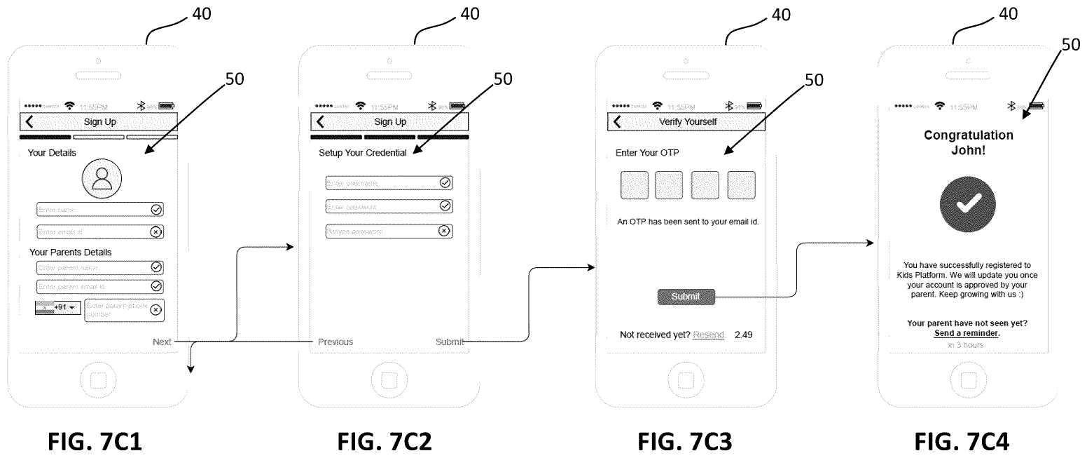

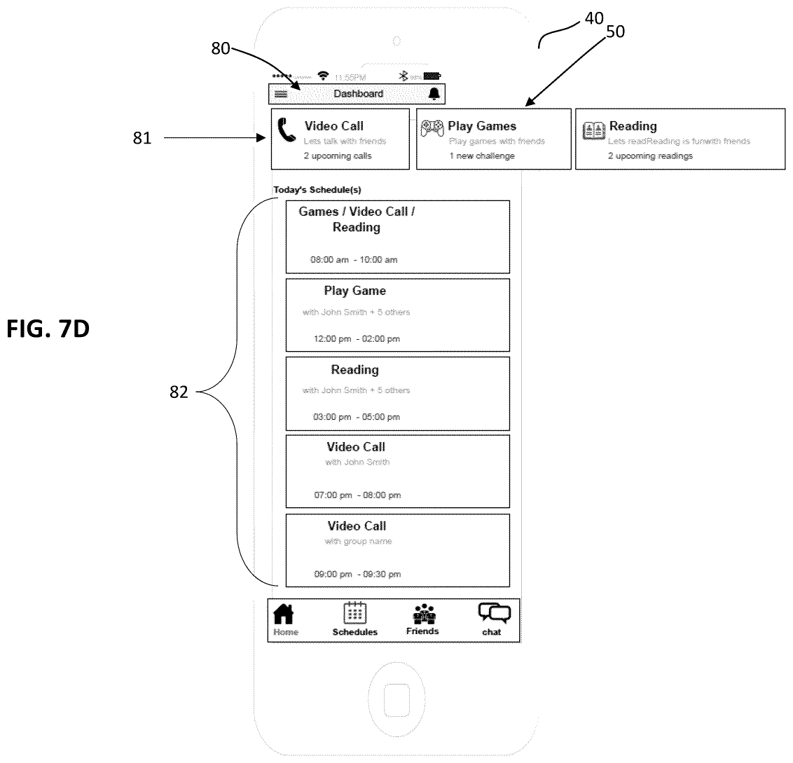

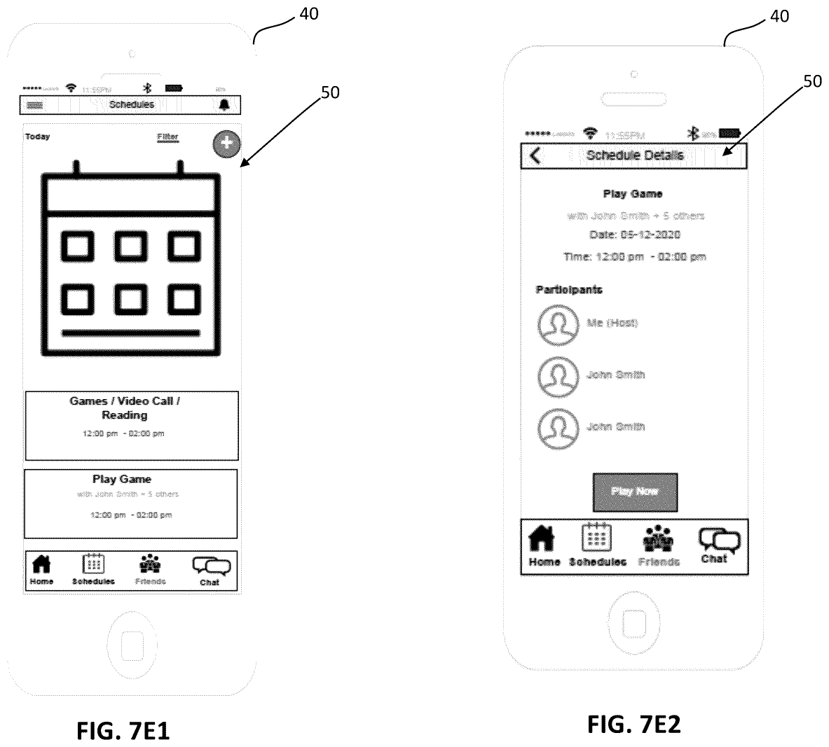

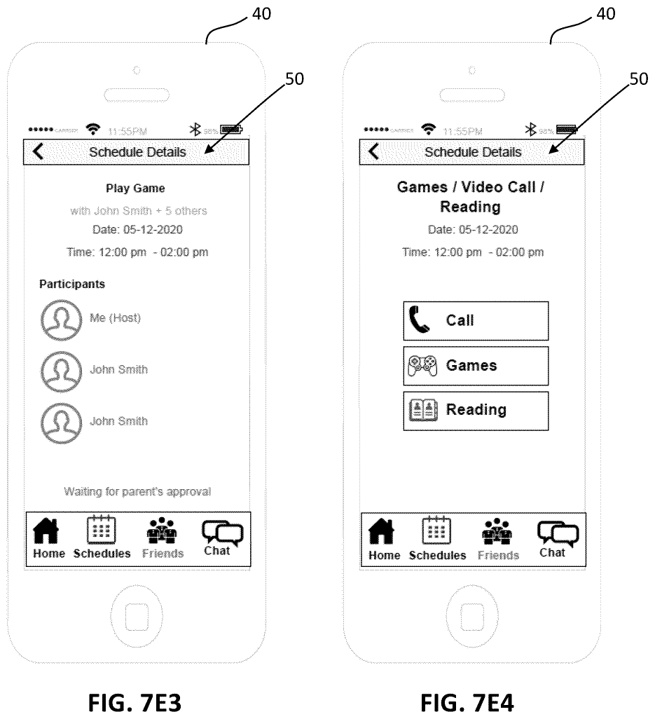

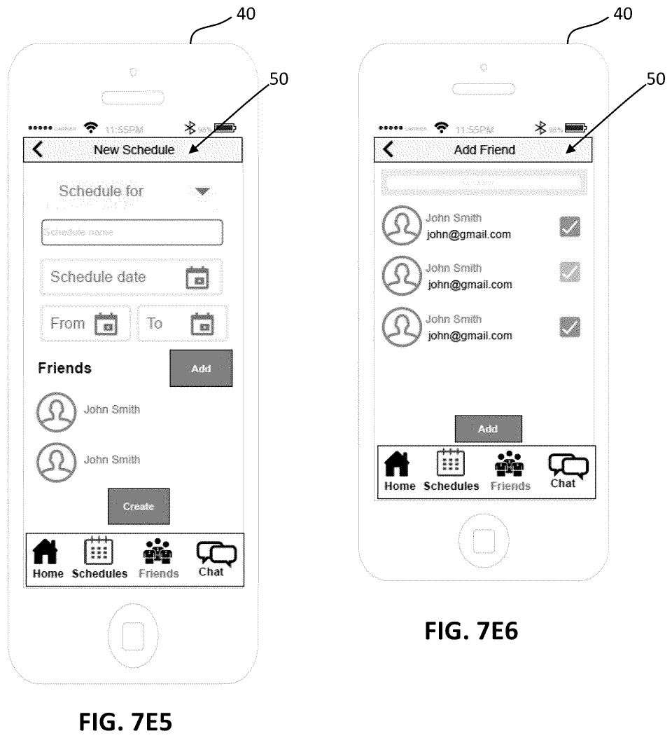

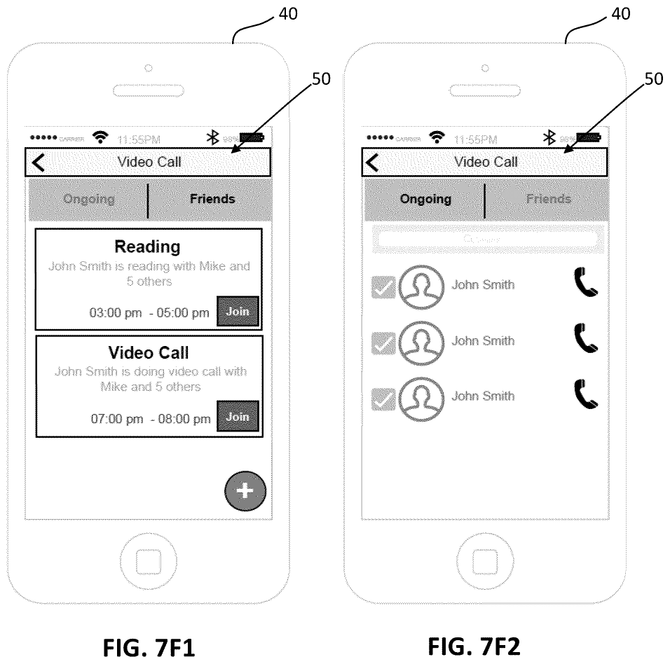

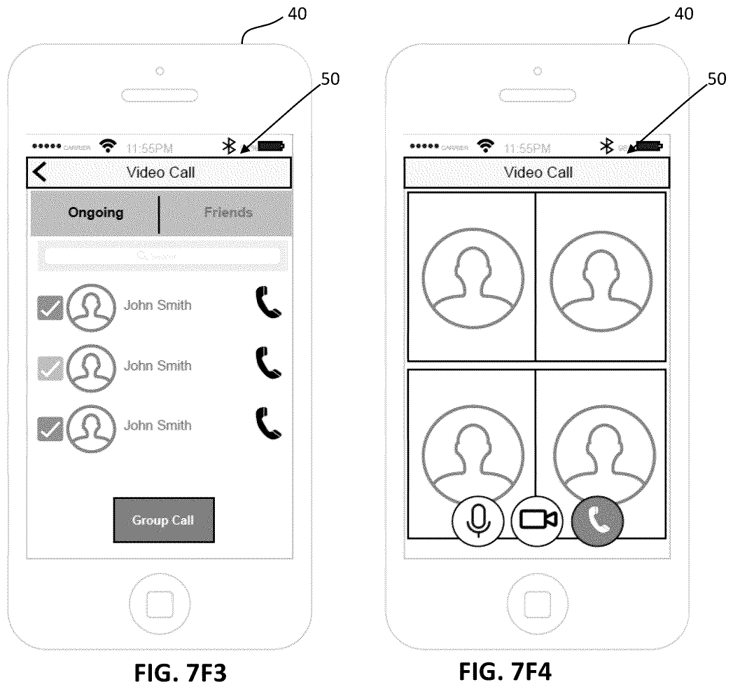

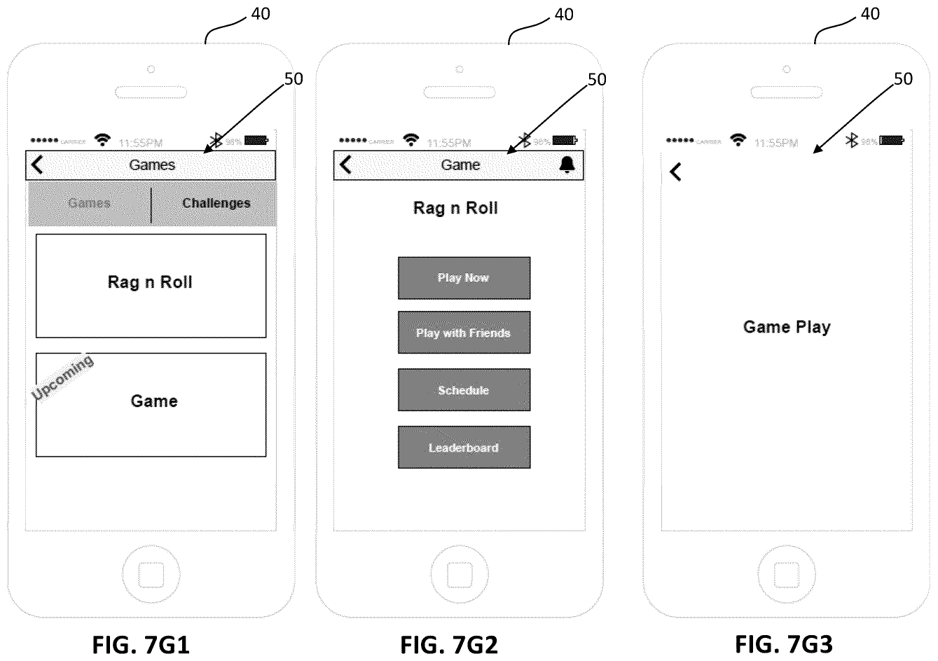

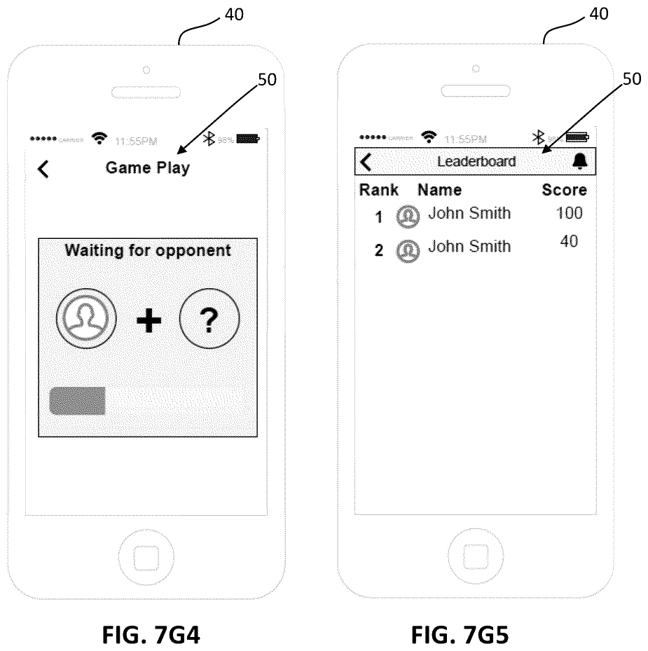

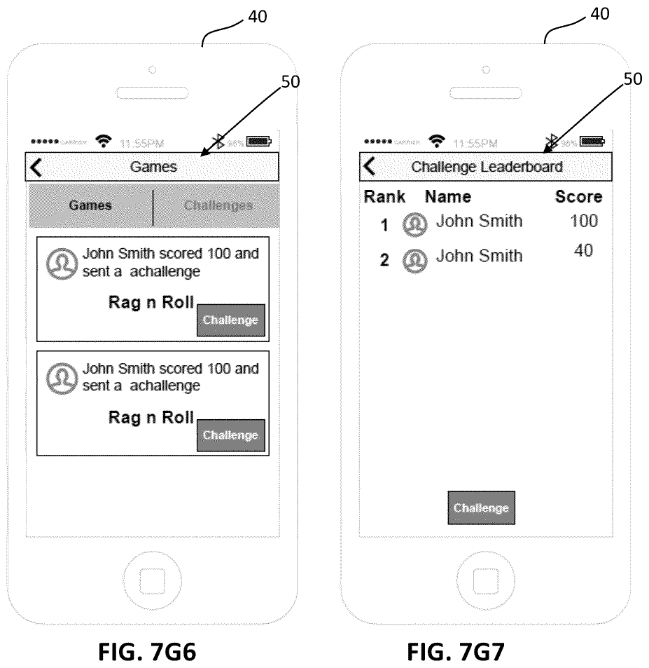

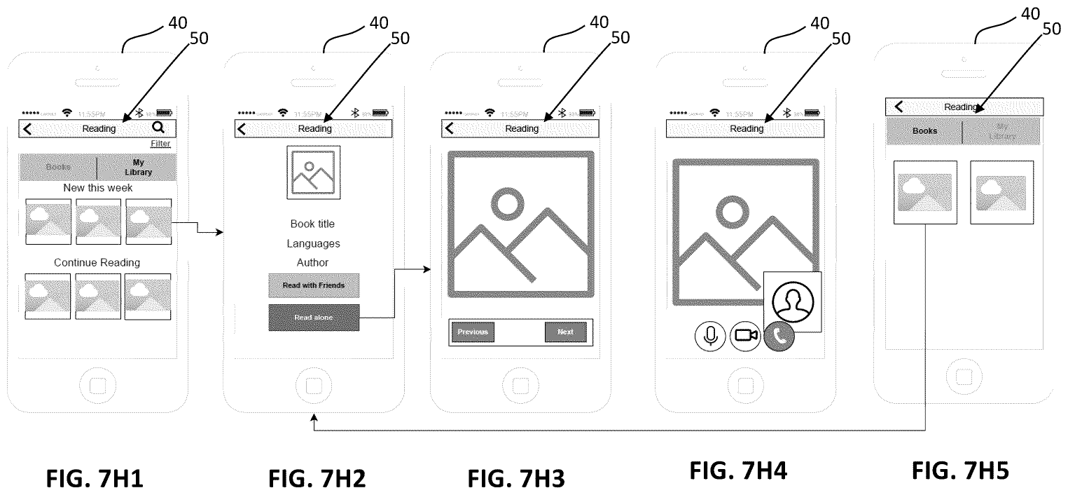

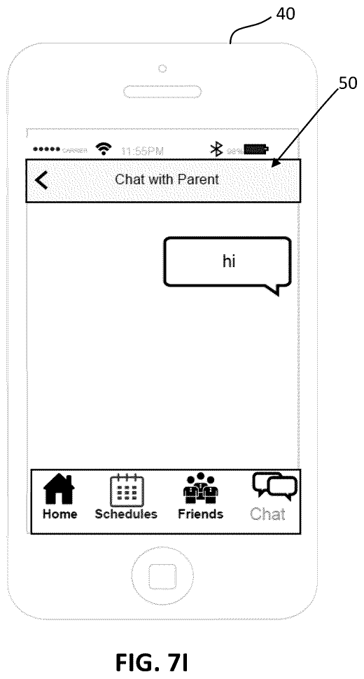

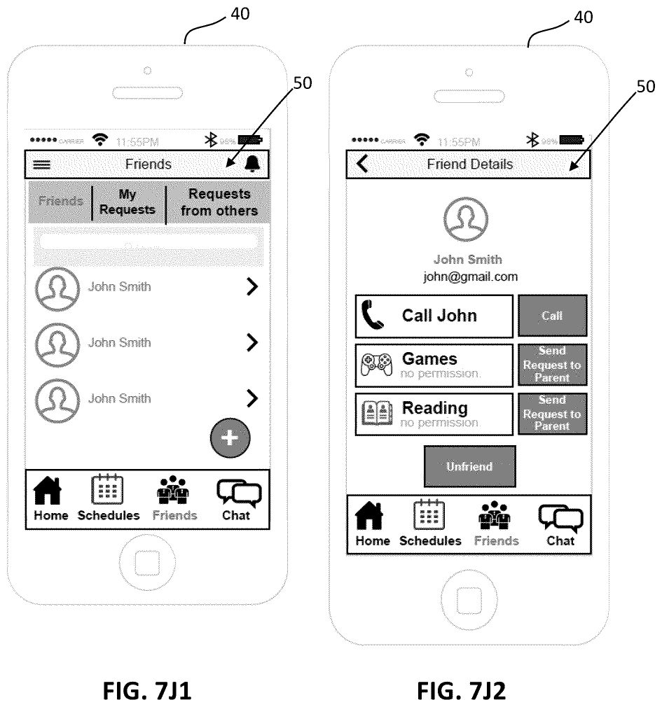

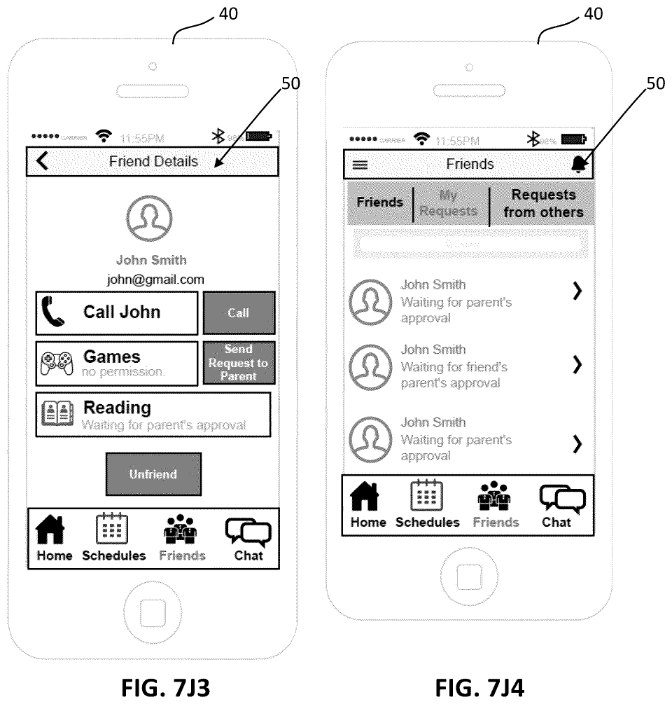

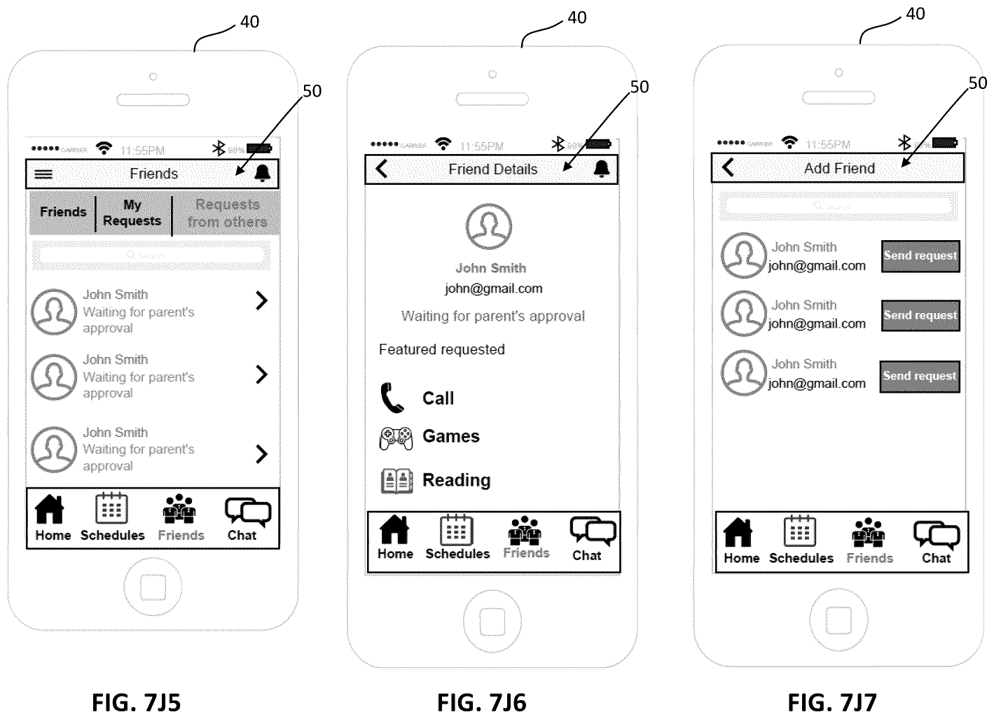

Furthermore, at reference 302 in FIG. 5A, illustrating the signup/login flow for a child or participant, if the child is an existing user, the child will login to the system 10 or method 100 using his or her previously assigned, acquired or provided credentials at 303. With reference to FIG. 7A1, an exemplary login screen or module 303 is shown for a child or participant to access the system 10 or method 100 of the present invention.

If, on the other hand, the child or participant is not registered, then the child or participant may do so, as referenced at 304, by providing identifying information (e.g., name, email address, phone number, password, etc.) For example, as shown in FIG. 7B, when a user selects “sign up now” or otherwise indicates a desire to register, in some embodiments, the user may be provided the option to identify as a parent or as a child. Selecting to sign-up as a child (or other participant) will, in some embodiments, direct the user to the child sign up module 304, as exemplified in the screenshot flows of FIG. 7C1-4. More specifically, as shown in FIG. 7C1-2 a user/child may provide various identifying or other registration information, such as name, phone number, email address, etc. to register an account or profile with the system 10 or method 100. In some cases, as shown in FIG. 7C3, a one-time password (OTP) or other like method may be provided to the user/child (e.g., via email, text message, etc.) for purposes of authenticating the information provided by the user. Other multi-factor authentication methods or processes may be implemented in other embodiments to provide additional authentication of the identity of the user and/or the accuracy of the identifying information provided thereby.

Next, with reference again to the high-level flow chart of FIG. 3, and in particular to box 106 the method 100 of at least one embodiment includes or requires the parent(s) account or profile to be linked to or otherwise associated with one or more child accounts or profiles. More specifically, in order for the parent or guardian, as referenced herein, to manage one or more child accounts (e.g., approve/disapprove requests, chats, playdates, etc., as disclosed herein), the parent account must be linked to or associated with the child account. This may be accomplished in several ways.

For example, one such way to link or associate a parent and child account within the scope of the present invention may be for the parent (through the parent account or device) to add a child to his/her account or profile. This can be seen in the flow chart of FIG. 4A at 206 where a parent has elected to add a child. Adding a child may require the parent to enter identifying information, such as the child's name, a user name, email address (if any), phone number (if any), etc. If the child has already registered with the system 10 and/or method 100, for example, in the manner described above, then the parent may use an account identification (account ID) assigned by the system 10 or method 100 to the child account. This will link the parent and child accounts, allowing for the parent to manage the child account, as described herein.

If, on the other hand, the parent elects to add a child prior to the child registering, or without a child account ID, then the parent may do so, by again providing identifying information for the child, e.g., name, user name, password, email address, phone number, age, etc. This may, in some cases, generate a unique user identification or linking ID for the child. The child may then, at the time of registration or at a later time thereafter, enter the linking ID or user ID in order to link the child account to the parent account. This can be seen, for example, at 306 in the child signup flow chart of FIG. 5A. Again, the child may register or obtain an account without the user ID or linking ID, for example, as shown at 308. In that case, the child and parent accounts may subsequently be linked or associated with one another, for example, by entering the child account ID in the parent account (as provided above) or by entering the parent account ID in the child account/profile. For instance, FIG. 7A2 illustrates an exemplary screenshot where a child has registered without parental approval. In that case, the system 10 or method 100 of at least one embodiment will not let the child or participant any further into the application 50 without first receiving parental approval, or otherwise without first associating or linking the child account with a parent account.

It should be noted that other methods or manners in which to link or associate the parent account to or with the child account(s) are contemplated and within the full spirit and scope of the present invention.

Furthermore, it is possible that in some cases, a user, person, individual or even a bot (e.g., an autonomous or semi-autonomous program that is capable of interacting with the system or method of the present invention) may attempt to impersonate a parent or child. In other cases, a child may attempt to create an account on behalf of a parent in an attempt to bypass the requirement of certain embodiments of obtaining parental approval for certain features of the present invention. Accordingly, it may be beneficial to verify, validate or authenticate the identity of the parent, child or user creating the parent account or child account in order to minimize this type of attempted fraudulent activity.

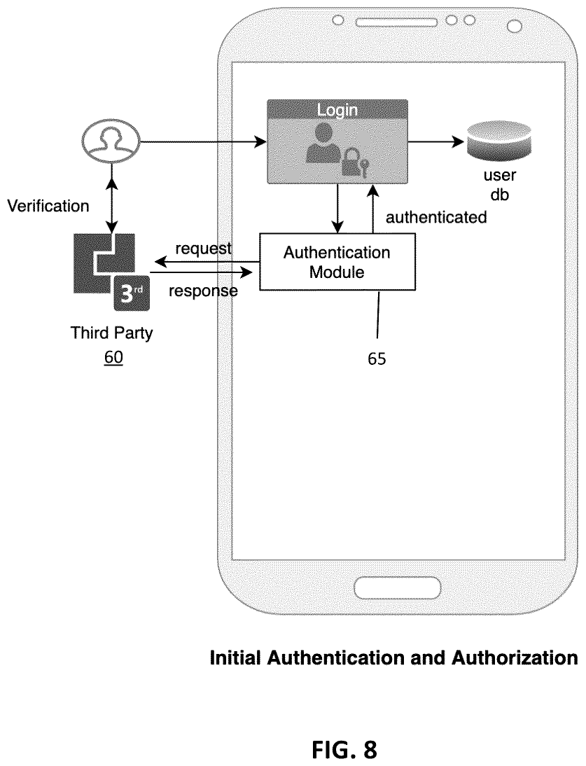

In this manner, with reference to the block diagram of FIG. 8, at least one embodiment includes an authentication or validation module, referenced as 65, for facilitating the verification or authentication of the user, attempted user, parent or child. The authentication module 65 may be implemented in software and/or may include hardware components and may, in some cases, be disposed on or in communication with the management system 20, on or in communication with the user device 30, 40, and/or both.

As shown in FIG. 8, the authentication module 65 of at least one embodiment, may be in communication with a third-party authentication/validation system 60 for further facilitating the authentication of the user. In some cases, the third-party authentication/validation system 60 may include one or more third-party websites or services which provide public records searches, or public or private information, such as identifying or personal information, e.g., name, email address, phone number, age, date of birth, place of birth, marital status, information pertaining to family members (e.g., whether the individual has any children), places of employments, residence information, criminal history, etc. Some non-limiting examples of such websites or services may include <idology.com>, <peoplefinder.com>, <spokeo.com>, etc.

Accordingly, in at least one embodiment, the system 10 and/or method 100 may communicate with the third-party service or website 60, e.g., via an authentication module 65, in order to verify or authenticate the identity of the individual or user who has registered, who is attempting to register, and/or who is linking or associating a parent account with a child account or vice versa. As just an example, a user, parent or child may be authenticated if and/or when at least some of the information provided in the corresponding account profile matches that retrieved from the third-party services or website. For instance, if the user's name, address and date of birth match, then the system or method of at least one embodiment may consider the user authenticated. Of course, in other embodiments, other information, including, for example phone number, physical address, social security number, phone number, place of birth, etc. may need to match in order for the system or method to consider the user authenticated.

With reference again to FIG. 3, and in particular to box 108, the method 100 of at least one embodiment may process this third-party authentication or validation at one or more times, e.g., at the time of, during or after the registration of the parent account/profile or child account/profile. In some cases, the authentication process may be activated at the time of, during or after associating a parent account with a child account, at the time of, during or after associating a child account with a parent account, etc.

With reference now to FIG. 6D, an exemplary parent or guardian dashboard 70 is shown. In particular, the parent or guardian dashboard 70 is provided to the parent or guardian on the parent device 30 once registration and login is successful. As illustrated, the parent dashboard 70 of at least one embodiment may show or include a section, referenced as 71, for “Pending Actions” or other like section. This section 71 may show pending “requests” such as request from a linked child account. As described below, the requests may include, for example, requests to connect with another user or child, requests to schedule a playdate, etc.

Still referring to FIG. 6D, the parent dashboard 70 of at least one embodiment may also include a section 72 illustrating or identifying a schedule for an associated or linked child account. In the example shown, the schedule shows fully approved activities or playdates scheduled for that particular day, although other schedules may show activities scheduled for the week, month, etc.

It should also be noted that, although not shown, using the parent dashboard 70 or application 50 of the present invention, the parent may edit his or her profile, edit application settings, review the terms and conditions, review the privacy policy, logout, etc.

FIG. 7D illustrates an exemplary child or participant dashboard 80 accessible by the child or participant via the application 50 on the child device 40. More specifically, the child or participant dashboard 80 may include several sections 81, 82 for displaying notifications, schedules, friend lists, chats, etc. In the example shown, the child dashboard 80 illustrates three notifications for activities related to video calls, games, and reading, along with a daily schedule illustrating upcoming activities. Of course, other dashboard or layouts are contemplated in order to facilitate the various features of the present invention and thus, the child and parent dashboards shown and described herein should not be considered limiting in any manner.

Referring again to the flow chart of FIG. 3, and in particular to box 110, in at least one embodiment, the method 100 includes a child requesting one or more actions or activities available within the application 50. As just an example, an action or activity, as used herein, may include requesting to connect with a friend within the application 50 (e.g., to virtually link the child account to another child account as a “friend”), requesting to schedule or conduct a video call with another user (e.g., a “friend” or another child account), requesting to play a game either individually or with another user (e.g., with a “friend” or another child account), requesting to participate in a reading individually or with a friend (e.g., to read with or listen to a reading through another user account), etc.

In certain embodiments, as shown at 112 in FIG. 3, each activity request. e.g., a friend request, a request to schedule a playdate (video call, play a game, read a story), must be approved by the parent(s) or guardian(s) associated with each of the child or participating user accounts. As just an example, a first child requests to be friends with a second child. In order for the system 10 and method 100 of at least one embodiment to accept the friend connection and link the first child account to the second child account, the parents or guardians for both of the child accounts must approve the request. As another example, using the application 50 or otherwise using the system 10 or method 100 of the present invention, a first child requests to schedule a video call (or other activity) with a second child and a third child. In order for the video call (or other activity) to be scheduled and before the video call can take place, the parent(s) or guardian(s) of the first, second and third child must first approve of the request and the activity.

It should be noted that a request for an activity, as used herein, may be generated through the application 50, for example, by selecting a corresponding button, menu item, drop down, etc. In many cases, such as, for a video call, game, or reading, the request for an activity will identify the participants of the activity (e.g., the requesting user or child, and the requested user(s) or child(ren)) as well as a date/time for the activity to take place. In this manner, the parent(s) or guardian(s) may approve of the request, decline the request, or in some embodiments, modify the request by proposing an alternative date/time.

For example, FIG. 6E illustrates an exemplary request sent to a parent account pending approval (accept) or disapproval (decline) thereof.

Once the request is approved, the activity is scheduled, as shown at 114, for the prescribed time and for the identified participants, users, child(ren) or parent(s). Accordingly, an identification of the scheduled activity will be added to each of the accounts associated with the request, for example, each of the children or participants identified in the request, as well as each of the linked or associated parent accounts. In some embodiments, the activity, once approved or accepted, will be scheduled, however, in other embodiments, the system 10 and/or method 100 may include a scheduling module or process which can be configured to automatically confirm that there are not any conflicting events scheduled for that day/time for one or more of the participants and/or to ensure or confirm that the participants, e.g., child(ren) are able to attend the activity based upon prior settings, schedules, parental controls, etc.

For instance, in at least one embodiment, a parent or guardian may define certain times and/or days in which a particular child may access certain features of the application 50, in which the particular child may participate in an activity, in which a particular child may interact with any other child account or certain defined or selected child accounts, etc. Accordingly, a parent may set parental controls or otherwise set a temporal access range or temporal restriction that defines when the associated child account can participate in an activity using the application 50. As just an example, the temporal access range may be set for Monday, Wednesday and Friday between 2:00 pm and 5:00 pm. In this manner, if the requested activity includes a day or time outside of that predefined temporal access range, then in some embodiments, the scheduling module will automatically decline the request, and may in some cases, notify the parent.

In another example, the parent or guardian may set or define a total access time (e.g., in minutes or hours) which will count down each time the child access the application 50 or participates in an activity. For example, the parent may set an access time of seven hours (e.g., per week). In order for the child to access the system 10 or method 100, or to otherwise participate in the activity features disclosed herein, the child must have available access time in order to do so.

For example, FIGS. 4B and 4C illustrate exemplary flow charts for a parent to manage requests (FIG. 4B) and set access times or access ranges (FIG. 4C). Specifically, the activity requests are sent to the parent of the requesting child (at least first) for approval, and then sent to the parent and/or child of the requested participant. For instance, as shown at 210, 212, if the parent has pending requests, the parent can view the request(s), such as on the dashboard as previously described or elsewhere. If the request is declined, the requesting child is notified, as shown at 214. On the other hand, as shown at 216, if the request is approved, then the requesting child is notified, as well as the requested child and in some cases the parents of the requested child.

With reference to FIG. 4C, if the parent account is associated with one or more child accounts, as shown at 218, the parent can view the access times or temporal access range associated with each child 220 and/or define the access times or temporal access range 222. This may all be accomplished through the application 50 or dashboard of the present invention.

Furthermore, FIG. 5B is a flow chart that illustrates the scheduling process or the schedule module in accordance with at least one embodiment of the present invention. For instance, with reference to 310, 312 the system 10 or method 100 will check if the child has an existing schedule, and if not, will create one. As shown at 314, if the scheduled time (e.g., of the requested activity) overlaps with or otherwise falls within the predefined temporal range or access times, then the schedule is approved 316. If the request is not within the access range, then the schedule is sent to the parent 318. If the parent declines the schedule or request, then the child is notified 320. If the parent approves the schedule or request, then the child is notified, as well as the other parents 322. If the other child's parent declines the request, the child is notified 324. Otherwise, if the other child's parents approve of the request, then the child and other parent are both notified 326. Still referring to FIG. 5B, if the request is approved by all of the parents of the participants, then the activity may be added to all of the participant's schedules or calendars.

For reference, FIGS. 7E1-6 are representative of exemplary screenshots showing the child's schedule within the application 50 of at least one embodiment of the present invention. IN particular, though the scheduling screens or module, all of the schedules created by the parent(s) and/or child are shown, along with the corresponding status of each, such as whether the schedule or request is pending, approved, partially approved, declined, etc. Clicking on or selecting a schedule will direct the application 50 or child user to a schedule detail screen (e.g., FIGS. 7E2-4) where the child can view the date and time of the schedule or activity, along with an identification of the corresponding participants of the activity. As shown in FIG. 7E5, the child can also create a new schedule or request for an activity and send it to the associated or linked parent/guardian account for approval.

With reference back to the high-level flow cart of FIG. 3, at the scheduled day/time of an approved activity, as shown at box 116, the scheduled activity may begin or otherwise activate. In various embodiments, the activity is conducted directly through the application 50 where it can be monitored and controlled, as described herein. Turning to FIG. 5C, a more detailed flow of the activity process is shown. For instance, in order to begin the activity (e.g., phone call, video call, game play, reading, etc.), the child must have the activity scheduled and the activity must have been approved by the child's associated parent(s) or guardian(s), as shown at 330, 332. Furthermore, and still referring to FIG. 5C, in order to begin the activity, in at least one embodiment, the child must also have access times available. This may mean that the activity time falls within predefined access time range or in some embodiments a parent may define a certain total number of hours or minutes the child may use the application. In that case, while the child uses the application, the defined access times will count down. In either way, in order to begin the activity, the child must be within the defined time range or have available access time assigned to his/her account 334. The friends or other participants of the activity must also have available access times or be within the predefined or prescribed access time range, as shown at 336, 338.

FIGS. 7F1 through 7H5 illustrate exemplary, non-limiting, screenshots of various activities that may be conducted through the application, such as, a vide call (FIGS. 7F1-7F4), playing a game (FIGS. 7G1-7G7), and participating in a group reading (FIGS. 7H1-7H5).

More specifically, with reference to FIGS. 7F1-7F4, all ongoing calls from the child's friends are shown. The child can send a join request to other child accounts or friends which when/if accepted by the host will allow the child to participate in the call. A child can also call the available friends directly using the application 50 and/or select multiple friends and create a group call.

Referring now to FIGS. 7G1-7G7, several exemplary, non-limiting, screenshots are shown representing the game play activity of at least one embodiment of the present invention. In particular, The application 50 shows a list or identification of available games as well as upcoming games (FIG. 7G1). Clicking on or selecting a game will take the user to the game details page or screen where the user can play the game directly (e.g., on his or her own with artificial intelligence or AI) or play with one or more friends in a multiplayer mode. After a game is played, the child may send a challenge which will be available to all friends. The child can also schedule a game with one or more friends in a similar manner as he or she can schedule a video call as previously described. In some cases, the system 10 or method 100 may maintain a leader board associated with the game, which can be viewed by the child. A challenge section (FIG. 7G6) shows all challenges sent by the child's friends. Clicking on a challenge may take the child to a details page or screen where the child can view the leaderboard (FIG. 7G7) of that challenge in order to attempt to beat the score(s) shown thereon.

FIGS. 7H1-7H5 show exemplary, non-limiting, screenshots of the group-reading activity of at least one embodiment of the present invention. In particular, as shown in FIG. 7H1, several books, stories, novels, etc. can be shown, sometimes organized in categories or genres, author name, book name, etc. A search feature may be included to allow the user to search for reading material based on keywords, author name, title, genre, etc. After selecting a book or reading source, the application 50 may show a details scree (e.g., FIG. 7H2). The child may choose to read alone (FIG. 7H3) or to read with friends (FIG. 7H4). In some embodiments, the child may be able to maintain a library or a collection of books or reading sources (FIG. 7H5) for access at a later time.

Additional features of at least one embodiment of the present invention allow users to chat with one another through typed text messages, as shown for example in FIG. 51. In this manner, a child can chat with his/her parent or guardian through the application 50 using the chat feature or chat module, as shown in FIG. 51. This can allow the child to ask for approval of certain pending requests, ask questions, or have open-ended conversations. In some cases, a child may only chat with an associated parent account, while in other embodiments, the chat feature or module may be available for a child to chat with friends or other users of the system 10 and method 100 of the present invention.

With reference now to FIGS. 5D and 7J1-7, the friends feature or friends module of at least one embodiment of the present invention is shown. More specifically, as shown in the flow chart of FIG. 5D, if the child has friends associated with his or her account or profile, then the child may be able to view a list of the friends 340, for example, using the child dashboard or through other features of the application 50. In order to connect with a friend through the system 10 and method 100 of at least one embodiment, the child may send a friend request through the application 50. In at least one embodiment, before that friend request is sent to the other child (e.g., the requested child), the friend request must first be approved by the requesting child's parent or guardian 342. If the friend request is approved by the requesting child, then the friend request is sent to the other child (e.g., the requested child) and the other child's (e.g., the requested child) parent(s) or guardian(s) 344. In some cases, the request will be sent to the other child's (e.g., the requested child's) parent or guardian first, and then if approved, to the requested child. In any manner, if the other parent(s) (e.g., the requested child's parents) approve the request, then the requested child and the requesting child are both notified and the children are connected as friends 346. If the other parent (e.g., the requested child's parent) declines, then the children are not linked as friends 348 and one or both of the children are notified.

FIGS. 7J1-7J7 illustrate exemplary, non-limiting, screenshots of the friends feature or friends module in accordance with at least one embodiment of the present invention. For example, in at least one embodiment, the friends section may be divided into multiple (e.g., three) parts or sections—a “Friends” section, a “My Requests” section, and a “Requests from Others” section (FIG. 7J1). The “Friends” section shows the list or identification of linked friends for the corresponding child or child account. Clicking on or selecting any friend will take the user to the friend detail page (FIG. 7J2-7J3) which show the details of the friend along with features and their availability based on parental permission or parental controls. The “Send Request to Parent” button (or equivalent) will enable the child to send a request to his/her parent in order to ‘unlock’ a feature with the friend. For example, in FIG. 7J3, it is shown that the “Reading” feature request is sent to the parent and awaiting approval.

The “My Requests” section (FIG. 7J4) shows all friend requests sent by the child. Clicking on or selecting a friend request will show the friend detail screen of FIG. 7J6, for example, where the current status will be shown along with the friend details and features. Clicking on a “+” button (or equivalent) will take the child to the “Add Friends” screen of FIG. 7J7 where the child can search for children registered to the system 10 and method 100 and send a friend request thereto (which will then notify the parent(s) in the manner described herein.).

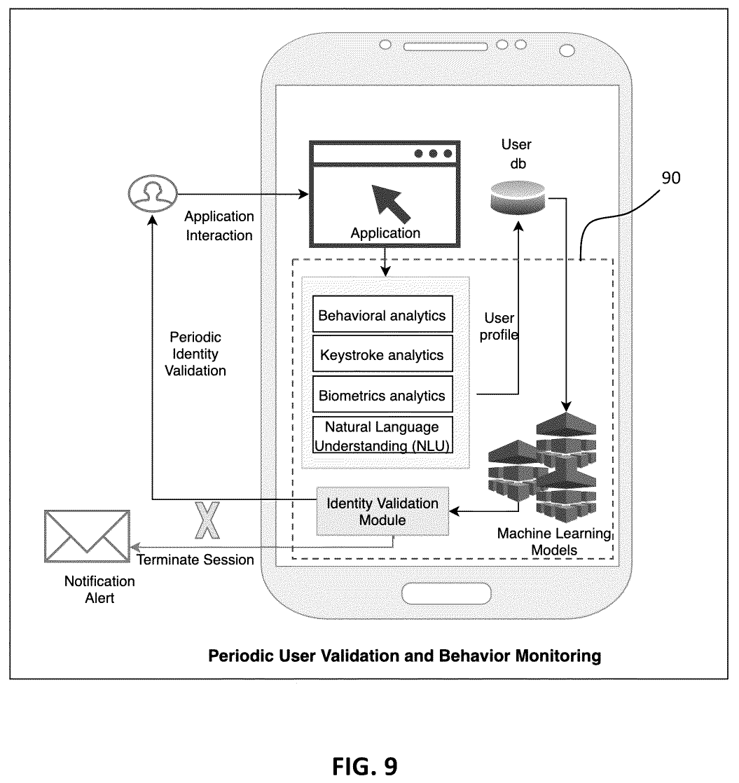

Referring again to the high-level flow chart of FIG. 3, and particular at box 118, as well as the block diagram of FIG. 9, at least one embodiment of the present invention also includes a behavior monitoring or analytics module 90 which, in certain embodiments, is configured to monitor behavioral and other aspects occurring on or through the application 50, system 10 or method 100, particularly during an activity (e.g., video or voice call, game, reading, chat messaging, etc.) in order to attempt to detect fraudulent, criminal, or negative behavior by one or more of the users. More in particular, the monitoring module 90 of at least one embodiment may be configured to periodically or continuously use artificial intelligence (AI), machine learning, natural language understanding (NLU) or other method or technique to monitor the tone, language, volume, and other behavioral elements of the users (e.g., parents and/or children), including physical movements in an attempt to identify any unwanted, criminal or negative behaviors, such as bullying toward one or more of the users, bullying toward another non-participating individual, sexual abuse, etc. More in particular, the monitoring module of the system 10 and/or method 100 of at least one embodiment may include a tone or sentiment analyzer to identify and/or block bullying, rude behavior, offensive content, strong or offensive language, etc. In some cases, the monitoring module also includes identity analytics using machine learning (ML) to monitor the users' key strokes, mouse behavior, swipe pattern(s), etc. in an attempt to identify any unwanted, strong, offensive or abusing activities. In some cases, a text to speech converter or a speech to text converter can be implemented in order to further monitor the users' behaviors, actions, interactions, etc. using the application 50, system 10 or method 100.

In the event, if any negative, abusive, offensive, or strong behavior or content is identified by the monitoring module 90, the system 10 and/or method 100 of at least one embodiment is configured to take corrective action, such as, but not limited to, immediately ending the activity, banning the offending user from the application 50, blocking the offending user from the application 50 for a defined time period, warning the offending user, sending notices to any impacted users (e.g., any children to whom the negative activity was directed, any children who may have witnessed the negative activity) and any and all associated parents, etc.

Furthermore, the built-in analytics, AI or other features of the monitoring module 90 of at least one embodiment of the present invention may include, for example, artificial intelligence (AI) or behavioral analytics (e.g., analysis of the time of day, user choice(s) and preference(s), location or geo-location of the users, etc.), keystroke analysis (e.g., key press duration, key navigation velocity, application screen switching or swiping velocity or frequency, session duration, etc.), biometrics (e.g., facial ID or recognition, retina scan, fingerprints, voice samples, etc.), and natural language understanding (NLU) (e.g., tone and tenor analysis, abusive language or bullying language, sexual language, sexual intonation, etc.)

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

1. A method for scheduling, managing and executing playdates, the method comprising:
creating a parent account at a management system via a parent device, the parent device comprising a computer processor memory and storage, the parent device being operated by a parent and disposed in a communicative relation with the management system via a communication network,
creating a child account at the management system via a child device, the child device comprising a computer processor, memory and storage, the child device being operated by a child and disposed in a communicative relation with the management system via the communication network,
associating the parent account with the child account at the management system,
authenticating the identity of the parent via an authentication module,
receiving a request, from the child account, to schedule an activity to be conducted with a requested child account, the request comprising a temporal element and an identification of the requested child account,
sending the request to the parent account associated with the child account for approval, sending the request to a parent account associated with the requested child account for approval,
if the request is approved by the parent account associated with the child account and the parent account associated with the requested child account, and if the child and the requested child have available access times, then scheduling the activity, and
at the scheduled time, conducting the activity via the child device.

2. The method as recited in claim 1 wherein the activity is defined as being selected from the following: participating in a voice call, participating in a game, or participating in a group reading session.

3. The method as recited in claim 1 wherein the authentication module is communicative with a third-party public records source, wherein identifying information corresponding to the parent are retrieved from the third-party public records source and compared to information provided in the parent account.

4. The method as recited in claim 3 wherein the parent is authenticated when a predetermined set of information matches between the corresponding user account and the third-party public records source.

5. The method as recited in claim 4 further comprising, during the activity, periodically evaluating behavioral elements of the participants for any indication of inappropriate behavior.

6. The method as recited in claim 5 further comprising defining the behavioral elements as comprising at least one of the following: vocal tone, language, vocal volume.

7. The method as recited in claim 6 further comprising defining the behavioral elements as further comprising physical movements exhibited during the activity.

8. The method as recited in claim 7 further comprising defining the behavioral elements as further comprising at least one of the following: key strokes, mouse behavior, swipe patterns.

9. The method as recited in claim 8 further comprising if an indication of inappropriate behavior is identified during the activity, then taking a corrective action commensurate in scope with the inappropriate behavior.

10. The method as recited in claim 1 further comprising, during the activity, periodically evaluating behavioral elements of the participants for any indication of inappropriate behavior.

11. A method for scheduling, managing and executing playdates, the method comprising:
creating a parent account at a management system via a parent device, the parent device comprising a computer processor memory and storage, the parent device being operated by a parent and disposed in a communicative relation with the management system via a communication network,
creating a child account at the management system via a child device, the child device comprising a computer processor, memory and storage, the child device being operated by a child and disposed in a communicative relation with the management system via the communication network,
associating the parent account with the child account at the management system,
receiving a request, from the child account, to schedule an activity to be conducted with a requested child account, the request comprising a temporal element and an identification of the requested child account,
sending the request to the parent account associated with the child account for approval,
sending the request to a parent account associated with the requested child account for approval,
if the request is approved by the parent account associated with the child account and the parent account associated with the requested child account, and if the child and the requested child have available access times, then scheduling the activity,
at the scheduled time, conducting the activity via the child device, and
during the activity, periodically evaluating behavioral elements of the participants for any indication of inappropriate behavior.

12. The method as recited in claim 11 further comprising defining the behavioral elements as comprising at least one of the following: vocal tone, language, vocal volume.

13. The method as recited in claim 12 further comprising defining the behavioral elements as further comprising physical movements exhibited during the activity.

14. The method as recited in claim 13 further comprising defining the behavioral elements as further comprising at least one of the following: key strokes, mouse behavior, swipe patterns.

15. The method as recited in claim 11 further comprising if an indication of inappropriate behavior is identified during the activity, then taking a corrective action commensurate in scope with the inappropriate behavior.

16. The method as recited in claim 15 further comprising authenticating the identity of the parent via an authentication module.

17. The method as recited in claim 16 wherein the authentication module is communicative with a third-party public records source, wherein identifying information corresponding to the parent are retrieved from the third-party public records source and compared to information provided in the parent account.

18. The method as recited in claim 17 wherein the parent is authenticated when a predetermined set of information matches between the corresponding user account and the third-party public records source.
